(19) United States
(12) Patent Application Publication
(10) Pub. No.: US 2011/0058921 A1
(43) Pub. Date: Mar. 10, 2011

(54) MOUNTING KIT

(76) Inventors: Barry McGrane, Clogherhead (IE); Kevin Turnbull, Knockbridge (IE); John McFadden, Anny (IE)

(21) Appl. No.: 12/864,083

(22) PCT Filed: Jan. 22, 2009
(86) PCT No.: PCT/EP2009/050725

§ 371 Date: Nov. 18, 2010

(30) Foreign Application Priority Data
Jan. 22, 2008 (IE) S2008/0041

(51) Int. Cl. B60P 3/06; B66F 9/075

(52) U.S. Cl. 414/373

(57) ABSTRACT

This invention relates to a mounting kit for fitting on the rear of a carrier vehicle chassis to receive a piggyback forklift truck having a pair of front wheels and a pair of height adjustable, forwardly projecting, load engaging tines. The mounting kit comprises a mounting frame having a pair of tine receiving sockets, a pair of forklift support receiving brackets and a pair of adjustable wheel abutment plates, one on each side of the tine receiving sockets, moveable forwards and backwards parallel to the longitudinal axis of the carrier vehicle. By having such an arrangement, various different forms of piggyback forklift truck may be mounted onto a chassis having the mounting kit thereon.

### INTRODUCTION

This invention relates to a mounting kit for a carrying vehicle chassis. More specifically, this invention relates to a mounting kit for fitting to a carrying vehicle chassis so that a number of different types of piggyback forklift truck may be mounted on the rear of that carrying vehicle chassis.

Piggyback forklift trucks are lightweight forklift trucks that are mounted on the rear of a carrying vehicle's chassis during transit to and from a customer's premises. Once at the customer's premises, the piggyback forklift truck is dismounted from the rear of the carrying vehicle and used to load goods onto or unload goods from the carrying vehicle's chassis. When the goods have been loaded or unloaded as appropriate, the piggyback forklift truck is mounted onto the rear of the carrying vehicle's chassis once more ready for onward transit. The mounting kit is provided to adapt the carrying vehicle's chassis so that the piggyback forklift truck may be securely fastened to the rear of the carrying vehicle during transportation.

One such type of mounting kit is that described in the applicants own U.S. Pat. No. 5,749,695. U.S. Pat. No. 5,749,695 discloses a mounting kit that may be mounted on carrying vehicle chassis' of varying sizes. There are however a number of problems with the existing mounting kits. Piggyback forklift trucks come in a range of shapes, sizes and weights. Furthermore, piggyback forklift trucks come with a variety of different load handling units, for example vertical masts and pivoting telescopic booms. Heretofore, each model of piggyback forklift truck requires a dedicated mounting kit dimensioned to receive that particular type of forklift. Typically, a mounting kit for one design of piggyback forklift will be totally unsuitable for another design of piggyback forklift. Therefore, if an operator wishes to upgrade their piggyback forklift, extensive modifications will almost certainly also be necessary to the chassis of their carrying vehicle. These modifications are time consuming and expensive to carry out.

Furthermore, in situations where an operator has a number of piggyback forklift trucks of different shapes, sizes, weights and load handling arrangements at their disposal, they have had to provide a separate carrying vehicle for each piggyback forklift truck with a mounting kit that suits that type of forklift. Not only is this expensive for the operator to provide, this also places limitations on the operator and prevents the operator obtaining the full benefit and flexibility of the fleet of piggyback forklifts and carrying vehicles that are at their disposal.

It is an object therefore of the present invention to provide a mounting kit for a carrying vehicle that overcomes at least some of these problems and provides a useful choice.

### STATEMENTS OF INVENTION

According to the invention, there is provided a mounting kit for fitting on the rear of a carrying vehicle chassis to receive a piggyback forklift truck having a pair of front wheels and a pair of height adjustable, forwardly projecting, load engaging tines, the mounting kit comprising:
a mounting frame having a pair of tine receiving sockets;
means to secure the mounting kit to the chassis;
a pair of forklift support receiving brackets; and
a pair of adjustable wheel abutment plates, one on each side of the tine receiving sockets, moveable forwards and backwards parallel to the longitudinal axis of the carrier vehicle.

By having such a mounting kit, the mounting kit may be used with a wide range of piggyback forklift trucks. The adjustable wheel abutment plates may be positioned appropriately to suit a particular wheel base of forklift truck. Furthermore, by providing a pair of forklift support receiving brackets, the operator may use the mounting kit with a number of different piggyback forklift truck mounting equipment, including tabs, mounting hooks and chains.

In one embodiment of the invention, there is provided a mounting kit in which the wheel abutment plates each comprise a fixed track, an abutment frame moveable relative the track and a releasable fixing member to releasably secure the abutment frame in position relative the track.

In one embodiment of the invention, there is provided a mounting kit in which the abutment frame is slidably mounted on the track.

In one embodiment of the invention, there is provided a mounting kit in which the abutment frame further comprises an inclined plate for bearing against the front wheel of the forklift truck.

In one embodiment of the invention, there is provided a mounting kit in which the pair of forklift support receiving brackets each comprise at least two jaws, each jaw defining a mounting pin receiving aperture, and a mounting pin slidably mounted in the mounting pin receiving apertures of the jaws.

In one embodiment of the invention, there is provided a mounting kit in which there are provided a pair of retractable wheel rest plates, moveable to and from a retracted stored position and an extended in use position, mounted on the mounting frame. This is seen as particularly advantageous. Depending on the model of piggyback forklift truck and the chosen mounting arrangement for that piggyback forklift truck, wheel rest plates may or may not be required. The retractable wheel rest plates allow the operator to use the wheel rest plates when necessary and stow the wheel rests out of the way when they are not required.

In one embodiment of the invention, there is provided a mounting kit in which the wheel rest plates are pivotally mounted on the mounting frame, pivotable to and from a retracted stored position and an extended in use position.

In one embodiment of the invention, there is provided a mounting kit in which the mounting frame comprises a foldable crash bar, the crash bar comprising a central portion and a pair of extension arms, one at each end of the central portion, the extension arms being foldable to and from a stored position and an extended in use position.

In one embodiment of the invention, there is provided a mounting kit in which the extension arms are pivotally mounted on the central portion, pivotable to and from a stored position and an extended in use position.

In one embodiment of the invention, there is provided a mounting kit in which the mounting frame further comprises a forward section and a rear section,
the forward section comprising a horizontal spacer bar and a pair of forward vertical spacer bars, one at each end of the horizontal spacer bar and projecting upwardly therefrom;
the rear section comprising a horizontal upper transverse crash bar, a lower transverse crash bar below the upper transverse crash bar and connected thereto by way of a pair of rear vertical spacer bars; and
the front section being connected to the rear section by way of the pair of tine receiving sockets being mounted adjacent their rearmost end on the lower transverse crash bar and mounted adjacent their front ends on the forward horizontal spacer bar.

In one embodiment of the invention, there is provided a mounting kit in which the mounting frame further comprises a pair of hanger plates connecting the front and rear sections, each hanger plate being connected to a forward vertical spacer bar and a rear vertical spacer bar.

In one embodiment of the invention, there is provided a mounting kit in which the mounting frame further comprises a pair of intermediate vertical spacer bars located between the pair of front vertical spacer bars and the pair of rear vertical spacer bars, and a horizontal structural bar connected to each of the intermediate spacer bars at their lowermost ends.

In one embodiment of the invention, there is provided in combination:
a piggyback forklift truck comprising:
   a chassis having a pair of front wheels and at least one steerable rear wheel;
   a drive unit mounted on the chassis for driving at least one of the wheels;
   a steering unit mounted on the chassis for steering the at least one steerable rear wheel;
   a load handling unit mounted on the chassis carrying a pair of height adjustable, forwardly projecting, load engaging tines;
   means to raise and lower the tines relative the chassis;
   means to extend the tines forwardly and retract the tines rearward relative the chassis;
   a forklift support mounted on the chassis; and
a carrier vehicle comprising:
   a carrier vehicle chassis having mounted thereon a mounting kit for the piggyback forklift truck, the carrier vehicle chassis mounting kit comprising:
   a mounting frame having a pair of tine receiving sockets;
   means to secure the mounting kit to the chassis;
   a pair of forklift support receiving brackets; and
   a pair of adjustable wheel abutment plates, one on each side of the tine receiving sockets, moveable forwards and backwards parallel to the longitudinal axis of the carrier vehicle.

### DETAILED DESCRIPTION OF THE INVENTION

The invention will now be more clearly understood from the following description of some embodiments thereof, given by way of example only, with reference to the accompany drawings, in which:—

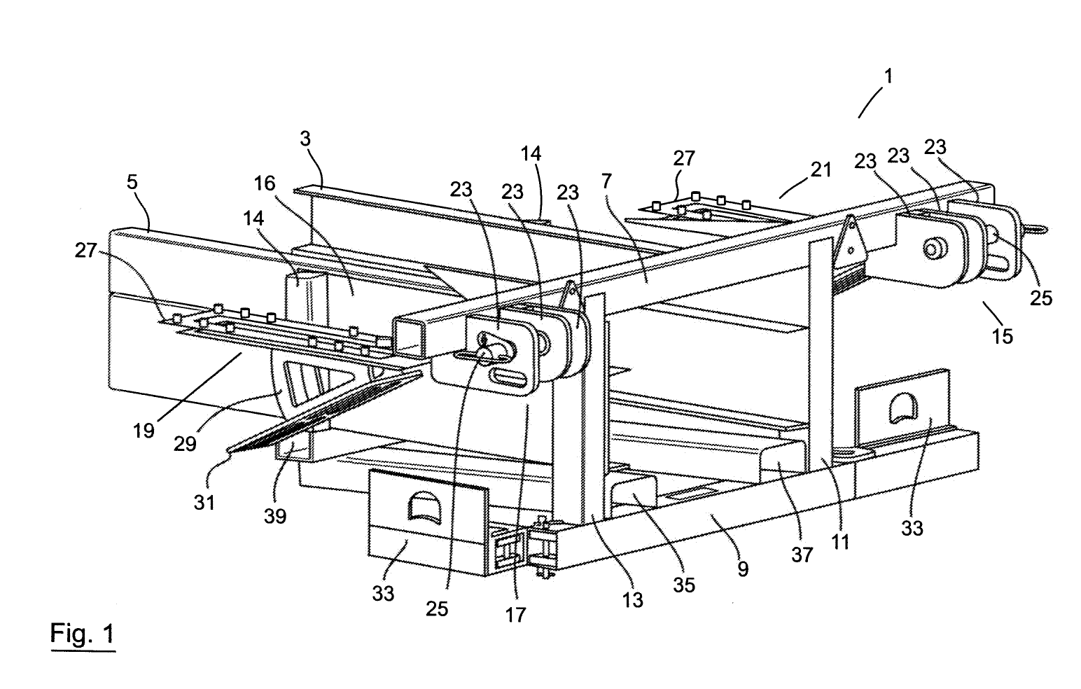

FIG. 1 is a perspective view of a first embodiment of a mounting kit according to the invention mounted on a carrying vehicle chassis;

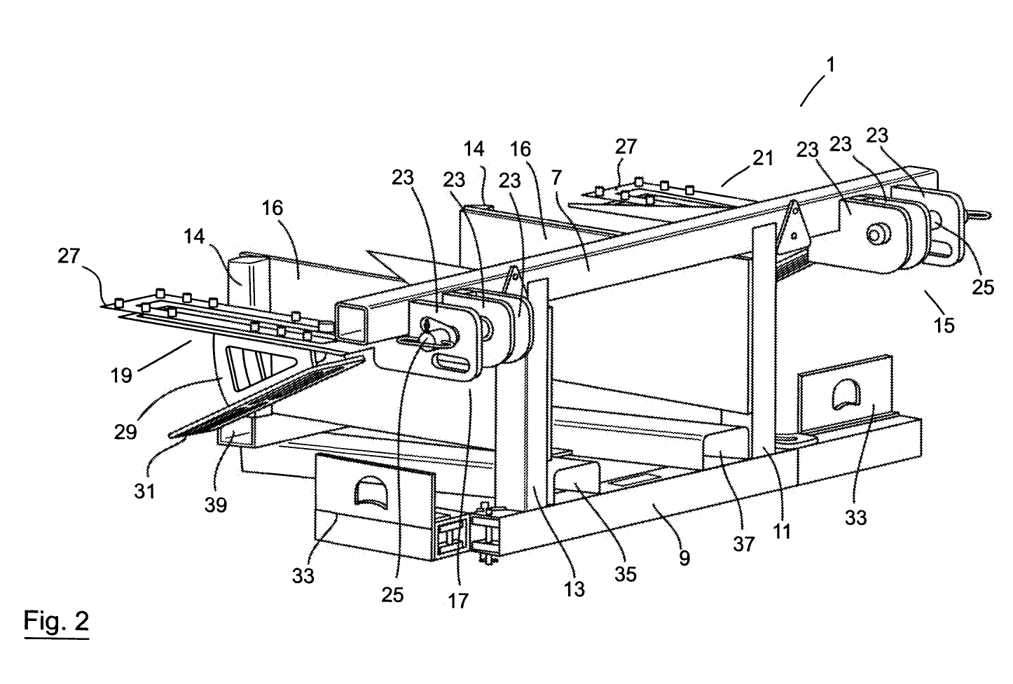

FIG. 2 is a perspective view of the mounting kit shown in FIG. 1 free of the chassis;

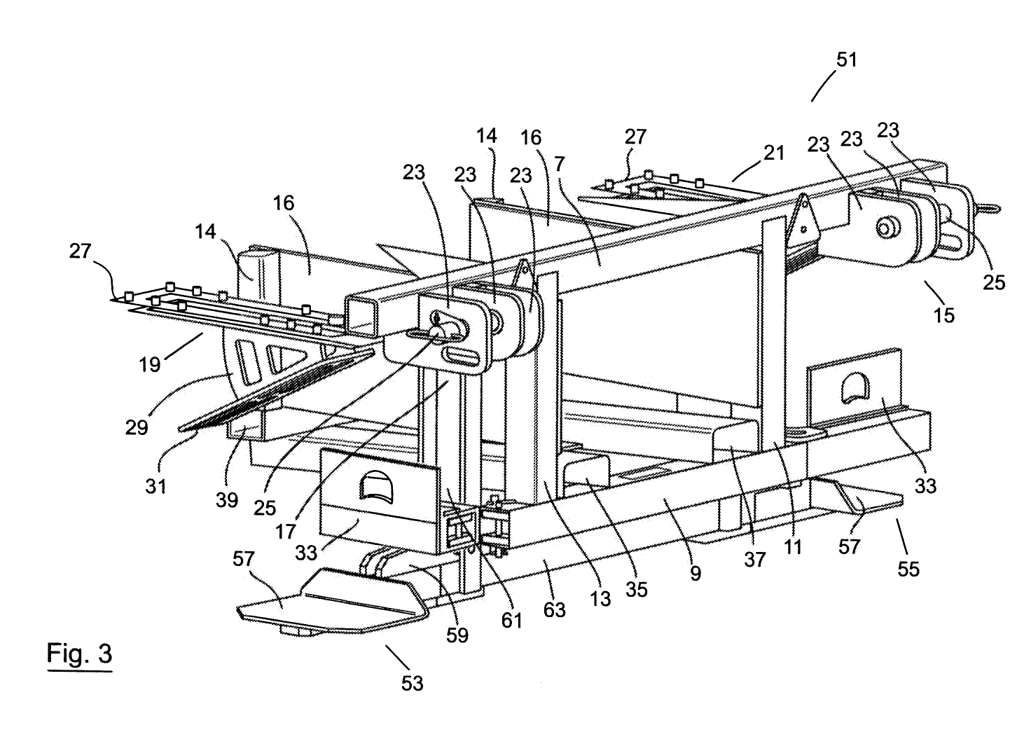

FIG. 3 is a perspective view of another embodiment of mounting kit;

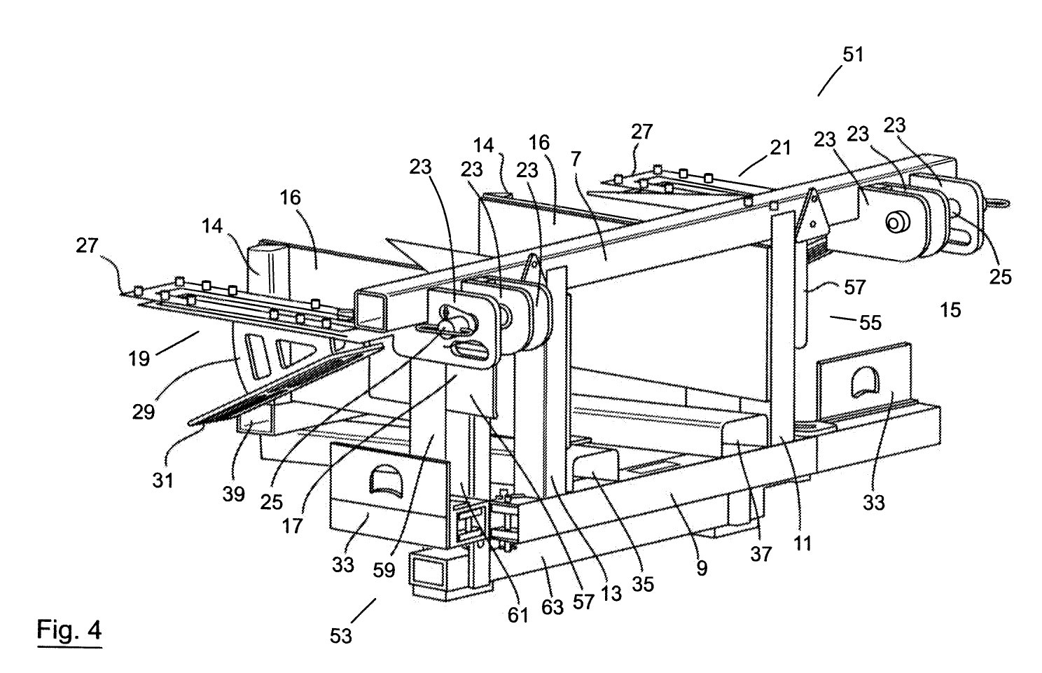

FIG. 4 is a perspective view of the mounting kit of FIG. 3 with the retractable wheel rests in a stowed configuration;

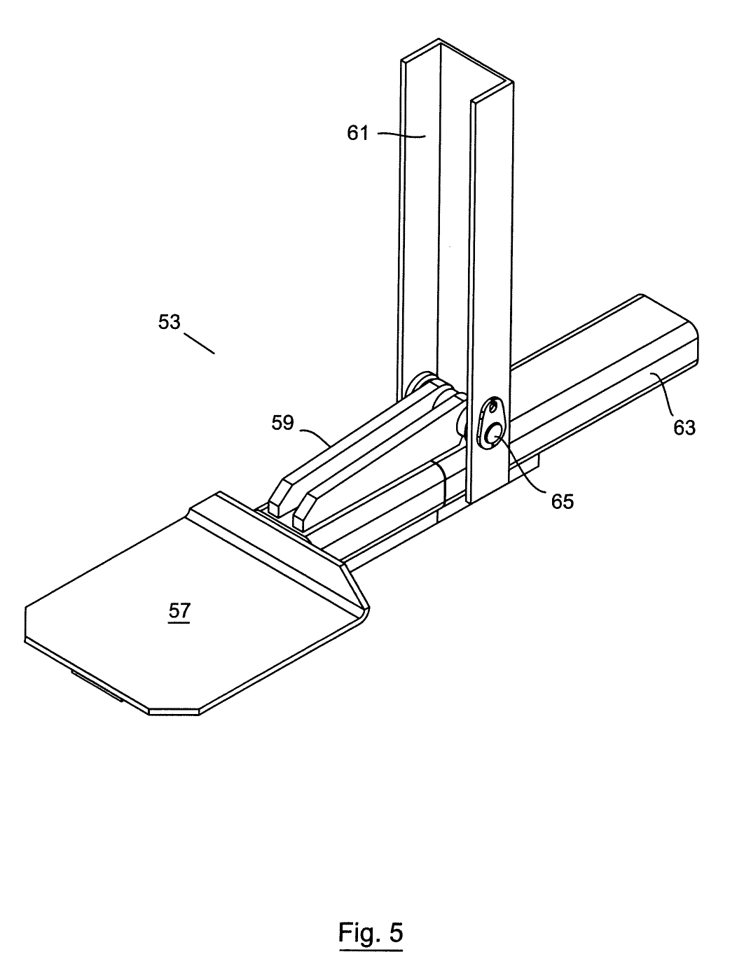

FIG. 5 is a perspective view of the retractable wheel rest of the mounting kit in an operating configuration;

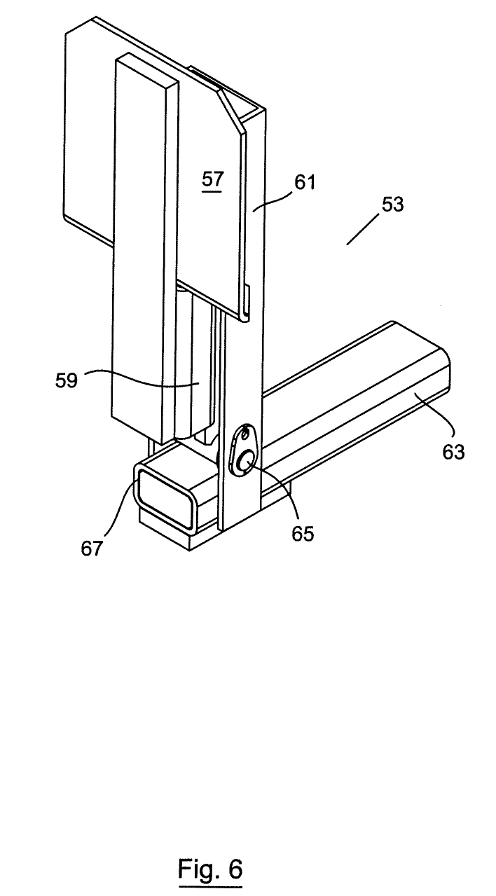

FIG. 6 is a perspective view of the retractable wheel rest of the mounting kit in a stowed configuration;

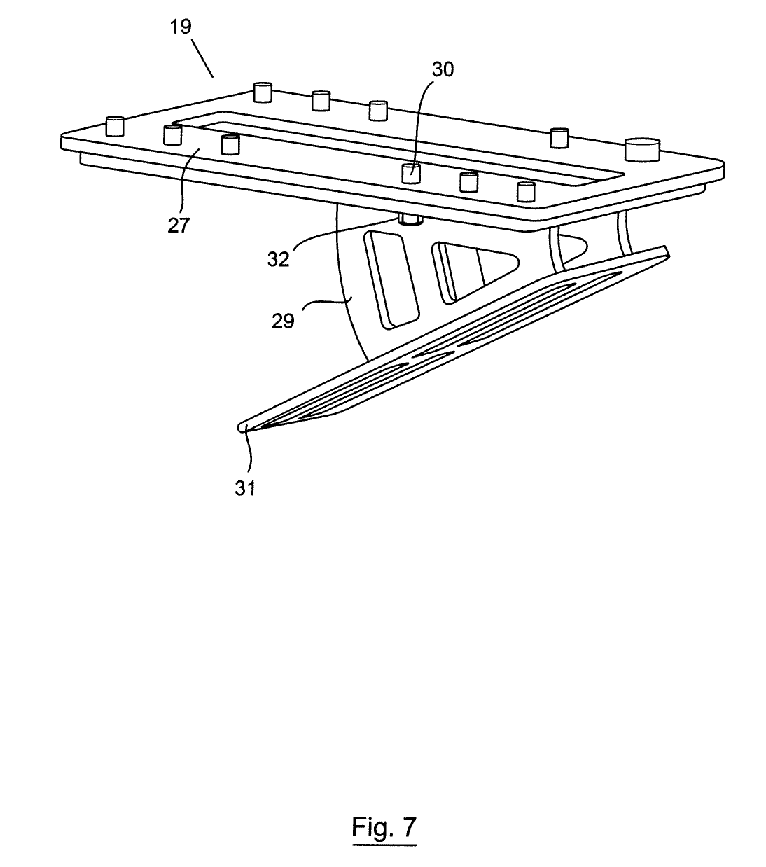

FIG. 7 is a perspective view of the adjustable wheel abutment plate of the mounting kit;

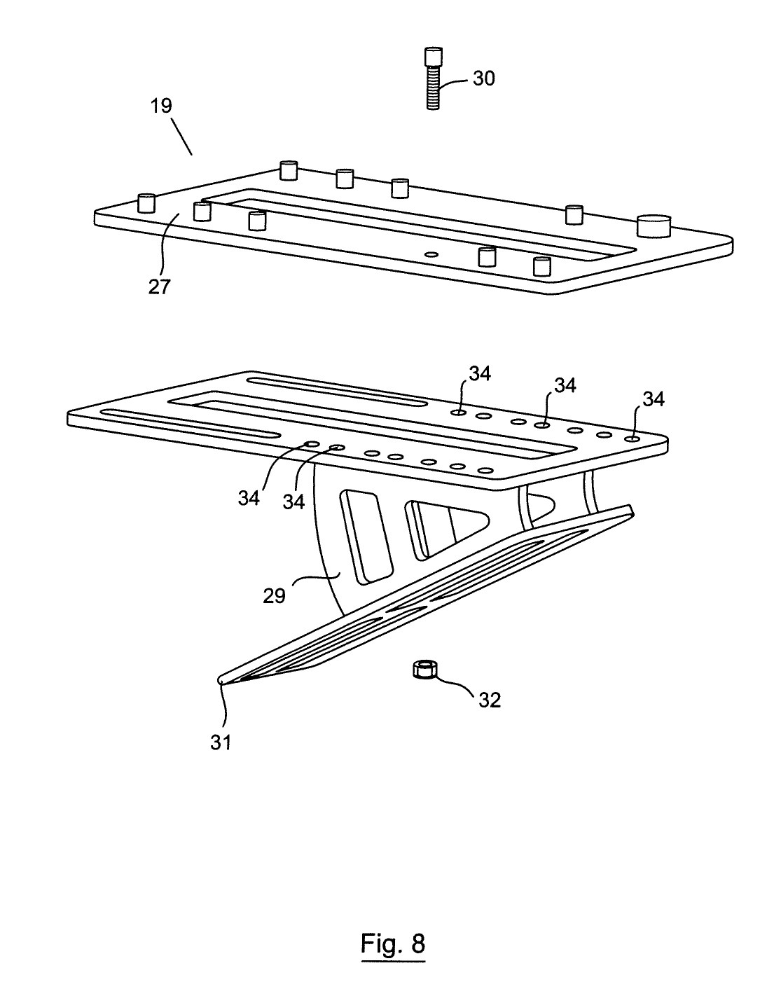

FIG. 8 is an exploded view of the of the adjustable wheel abutment plate of FIG. 7;

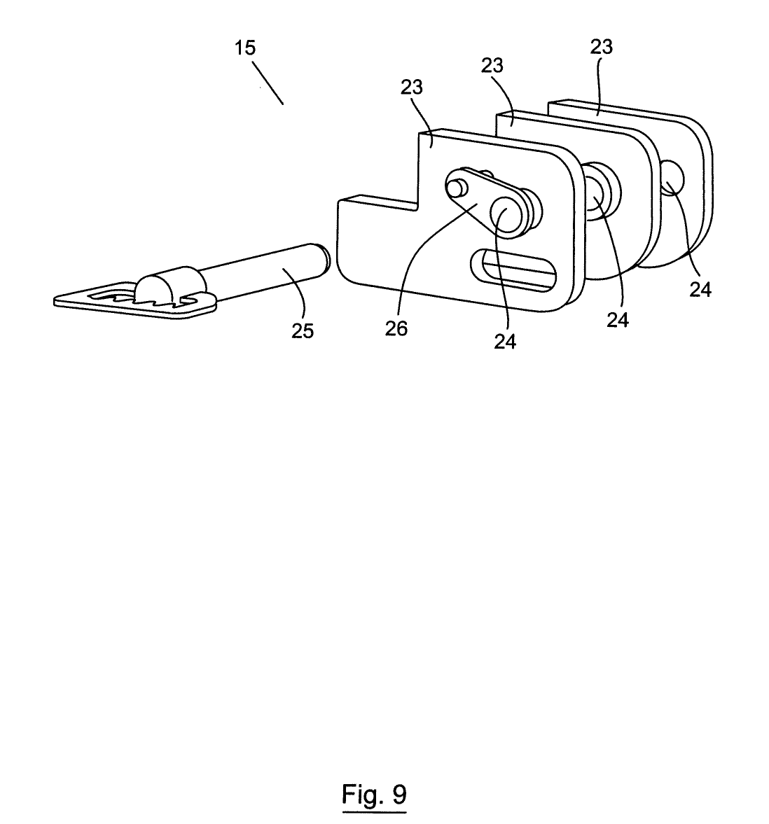

FIG. 9 is a perspective view of the forklift support receiving bracket of the mounting kit;

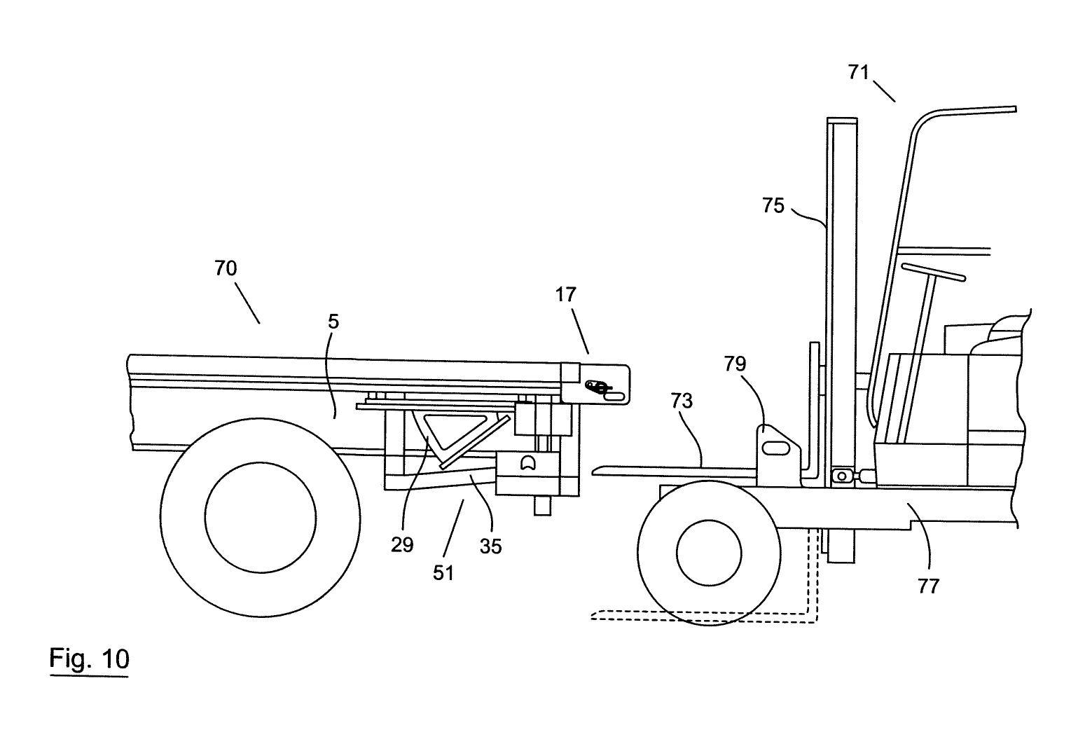

FIG. 10 is a side elevational view showing the rear end of a carrier vehicle with the mounting frame attached; and

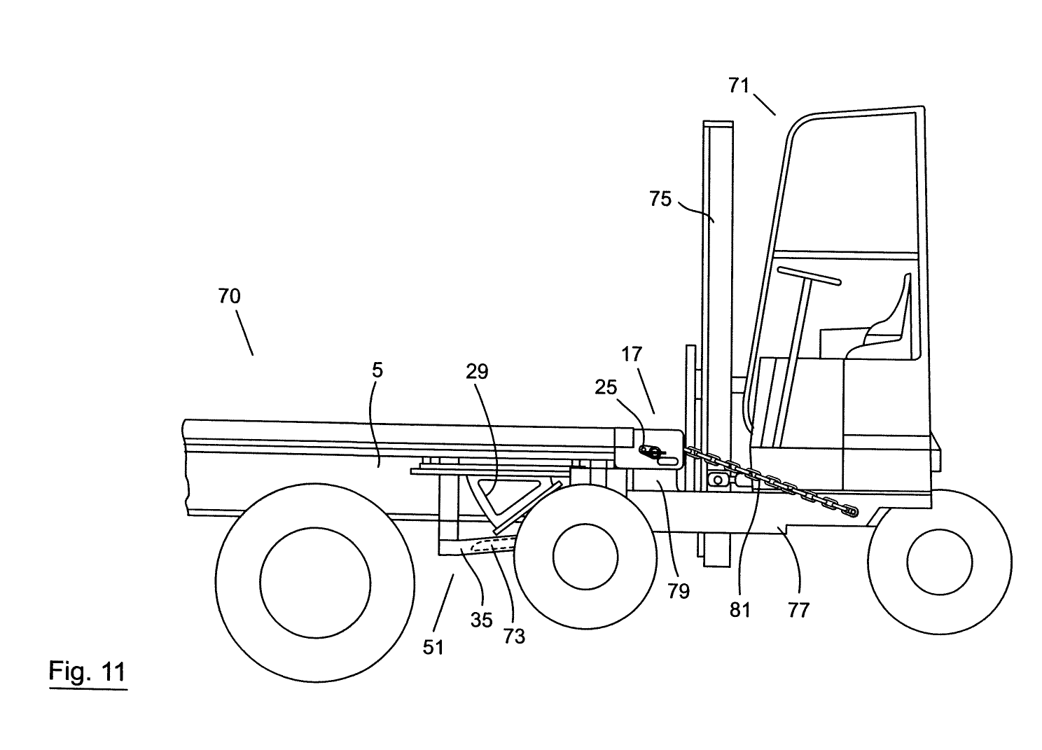

FIG. 11 is a side elevational view showing the rear end of a carrier vehicle with the mounting frame in use carrying a forklift.

Referring initially to FIGS. 1 and 2, there is shown a mounting kit, indicated generally by the reference numeral 1, mounted on a chassis of a carrying vehicle. The chassis comprises a pair of longitudinal structural members 3, 5. It will be understood that various parts of the chassis of the carrying vehicle have been omitted for clarity so that the parts of the mounting kit may be shown more clearly. The mounting kit 1 comprises a mounting frame 6 having a pair of tine receiving sockets 35, 37, a pair of forklift support receiving brackets 15, 17 and a pair of adjustable wheel abutment plates 19, 21.

The forklift support receiving brackets 15, 17 (FIG. 9) each comprise three jaws 23 welded to an upper transverse crash bar 7. Each of the jaws has a through bore 24 for reception of a horizontal mounting pin 25 and the horizontal mounting pin 25 is slidably mounted in the through bores of the jaws 23. A locking mechanism 26 is provided to releasably secure the horizontal mounting pin in position relative the jaws.

The adjustable wheel abutment plates 19, 21 (FIGS. 7 & 8) each comprise an elongate fixed track 27 and an abutment frame 29 movable relative the track 27. The abutment frame is moveable relative the track in a direction parallel to the longitudinal axis of the carrying vehicle chassis. The abutment frame 29 comprises an inclined plate 31 for bearing against the wheel of a forklift (not shown). The abutment frame 29 is slidably mounted on the longitudinal track 27 and means, in this case nut 32 and bolt 30, are provided to releasably secure the frame in position relative the longitudinal track. The means to secure the abutment frame in position relative the track could be provided by way of a number of nuts and bolts, a locking pin arrangement, a spring loaded locking pin or other such device. The abutment frame 29 has a plurality of apertures 344 for reception of a locking member therein to secure the frame 29 in position relative the track. The fixed track may be bolted onto the chassis of the vehicle or may be mounted on the chassis using other suitable means, for example by welding the track onto the chassis. Indeed, the fixed track may be fixed in position relative the chassis by being affixed in a similar manner to the mounting frame which in turn is secured in position relative the chassis.

Referring again to FIGS. 1 and 2, the mounting frame 6 comprises a forward section and a rear section, the forward section comprising a horizontal spacer bar 39 and a pair of forward vertical spacer bars 14, one at each end of the horizontal spacer bar 39 and projecting upwardly therefrom. The rear section comprises the horizontal upper transverse crash bar 7, a lower transverse crash bar 9 below the upper transverse crash bar 7 and connected thereto by way of a pair of rear vertical spacer bars 11, 13. The front section of the mounting frame is connected to the rear section by way of the pair of tine receiving sockets 35, 37 which are mounted adjacent their rearmost end on the lower transverse crash bar 9 and mounted adjacent their front ends on the forward horizontal spacer bar 39. The mounting frame 6 further comprises a pair of hanger plates 16 connecting the front and rear sections, each hanger plate 16 being connected to a forward vertical spacer bar 11, 13 and a rear vertical spacer bar 14.

The mounting frame 6 is connected to the longitudinal structural members 3, 5 of the chassis through the upper transverse crash bar 7 and the forward horizontal spacer bar 39 which are welded in position to the longitudinal structural members. Other parts of the mounting frame may also be welded in position to the chassis. As an alternative to welding, the mounting frame or individual parts thereof may be bolted to the chassis. Indeed, certain parts of the mounting frame, for example the upper transverse crash bar 7, may be integral with the carrying vehicle chassis and the remainder of the mounting kit is connected onto that part that is integral with the chassis.

The mounting kit 1 further comprises a pair of retractable crash-bar extension arms 33, one of which is mounted at either end of the lower transverse crash bar. One of the retractable crash-bar extension arms 33 is shown in an extended in use position substantially parallel to the central portion of the lower transverse crash bar and the other of the retractable crash-bar extension arms is shown in a stored position substantially perpendicular to the central portion of the lower transverse crash bar. The extension arm 33 is pivotable to and from the extended in use position and the stowed configuration substantially parallel to the longitudinal structural members 3, 5. When the extension arms 33 are in an extended in use position, they operate as a crash bar providing protection to the carrying vehicle and when the extension arms are in the stowed configuration, they will allow a forklift to be mounted on the carrying vehicle chassis.

In use, the operator of the piggyback forklift adjusts the wheel abutment plates by releasing any locking members 30, 32 and moving the abutment frame 29 relative the longitudinal track 27 so that the inclined plate 31 is at the desired position to accommodate the wheel base of the piggyback forklift (not shown). The locking members are then used to secure the abutment frame 29 in position relative the longitudinal track. Furthermore, the horizontal mounting bars 25 of the forklift support receiving brackets 15, 17 may be inserted through all of the through bores of the jaws 23 and fixed in place or may be left free of an adjacent pair of jaws until such a time as a tab of a forklift is in position between the jaws, or a chain has been placed between the jaws, ready to be engaged by the horizontal mounting bar. Once the tab or chain is in position, the horizontal mounting bar may be slid between the jaws engaging the tab or chain and then locked in position. Other forklift support arrangements, for example hooks and chains with suitable connectors, may allow the mounting pin to be locked in position before it is engaged by the hooks or suitable connectors on the chains.

Referring to FIGS. 3 and 4 of the drawings, there is shown an alternative embodiment of mounting kit 51 where like parts have been given the same reference numerals as before. The mounting kit 51 further comprises a pair of retractable wheel rest plates 53, 55. The retractable wheel rest plates 53, 55 each comprise a wheel receiving plate 57 mounted on an arm 59 which in turn is pivotally mounted on an intermediate vertical spacer bar 61. The intermediate vertical spacer bars 61 are located between the pair of front vertical spacer bars 14 and the pair of rear vertical spacer bars 11, 13, and a horizontal structural bar 63 is connected to each of the intermediate spacer bars 61 at their lowermost ends.

Depending on the construction of piggyback forklift to be mounted on the rear of the carrying vehicle, the retractable wheel rest plates 53, 55 may be required. If required, the wheel rest plates 53, 55 may be pivoted from a stowed configuration where they rest up against the intermediate vertical spacer bar 61 (FIG. 4) to a substantially horizontal operating configuration perpendicular to the intermediate vertical spacer bar 61 (FIG. 3). The intermediate vertical spacer bars 61 and retractable wheel rests are positioned on the chassis forward of the lower transverse crash-bar 9 and in a position that ensures that they do not interfere with the operation of the retractable crash-bar extension arm 33. The intermediate vertical spacer bars are so positioned that the retractable crash bar extension arm is able to pivot rearwards to a stored position substantially perpendicular to the central portion of the lower transverse crash bar and substantially parallel to the longitudinal structural members 3, 5.

Referring to FIGS. 5 and 6 of the drawings, there are shown perspective views of the retractable wheel rest plate 53 of the mounting kit 51. The arm 59 is pivotally mounted about a pivot pin 65 on vertical spacer bar 61 so that it pivots to and from an operating configuration, as shown in FIG. 5 and a stowed configuration, as shown in FIG. 6. Preferably, the operating arm 59 is dimensioned so that it abuts against an end 67 of the horizontal structural bar 63 when in an operating configuration, thereby limiting further downward movement of the arm 59 and wheel receiving plate 57.

Referring to FIGS. 10 and 11, there are shown views of the mounting kit 51 secured to a carrying vehicle chassis 70 and the mounting kit in use mounting a forklift 71 on the chassis. The mounting and dismounting procedure is well understood by those skilled in the art. In brief, in those forklift mounting arrangements that do not require the wheel rest plates, the extendable arms 33 of the transverse crash bar and the wheel rest plates are pivoted to a stored configuration and the tines 73 of the forklift may be offered up to the tine receiving sockets 35. The load handling unit 75 may be fully retracted or almost fully retracted on the forklift chassis 77 before the tines 73 are engaged in the tine receiving sockets. Once the tines are engaged in the tine receiving sockets, the tines 73 are lowered thereby raising the forklift 71 off the ground. The position of the tines on the mast 75 is manipulated until the forklift supports, in this case tab 79, mounted on the chassis are aligned with the forklift support receiving brackets 15, 17 on the carrying vehicle chassis 70. Once the forklift supports 79 have engaged the forklift support receiving brackets 15, 17, the locking pins 25 are inserted and secured in position in the jaws 25 and the pressure in the hydraulics of the load handling unit can be released so that the forklift is carried by the forklift supports with the wheels of the forklift abutting against the abutment frame 29.

For those mounting arrangements that require wheel rest plates, the wheel rest plates are lowered from a stored position to an extended in use position and the extendable arms of the lower transverse crash bar are pivoted into a stored configuration. The tines 73 of the forklift truck are extended by moving the load handling unit, in this case a vertical mast 75, otherwise referred to in the art as a static mast, forward on the forklift chassis 77 and the tines 73 are offered up to the tine receiving sockets 35, 37 at the rear of the carrying vehicle. The tines are engaged fully in the tine receiving sockets and the tines are lowered on the vertical mast. By lowering the tines on the mast 75, this has the effect of raising the forklift off the ground. When the wheels of the forklift are above the wheel rest plates, the mast may be retracted further on the forklift chassis thereby bringing the front wheels of the forklift under the carrying vehicle chassis and above the wheel rest plates. Forklift supports comprising one or more of tabs 79, hooks and chains 81 are attached to the forklift support receiving brackets and secured in place and the pressure in the hydraulics of the load handling unit can be released so that the forklift is carried on the wheel rest plates and by the forklift supports.

In the embodiment shown, the forklift truck is a piggyback forklift truck having a u-shaped chassis with a pair of front wheels and at least one steerable rear wheel. The u-shaped chassis has a rear cross bar and a pair of forwardly projecting side bars. The forklift truck further comprises a drive unit, a driver's station and a load handling unit, comprising a vertical mast, all of which are mounted on the chassis. Forklift support means, in this case tabs 79 and chains 81 are provided but could be hooks similar in construction to the tabs 79 shown but with an open mouth to allow engagement of a horizontal bar 25 mounted in the forklift support receiving brackets on the carrying vehicle chassis. Furthermore, tabs, hooks or chains could be provided as the sole forklift support for engagement of the forklift support receiving brackets if desired. Other load handling units such as a pivoting boom arrangement could be used instead of the upright mast on the forklift without departing from the scope of the invention.

It will be understood that various modifications could be made to the present invention, without departing from the scope of the invention. For example, two jaws 23 could be provided instead of three for each of the forklift support receiving brackets and the horizontal mounting pin may be permanently mounted between the jaws for engagement of certain types of mounting kits of piggyback forklifts. However, it is envisaged that the horizontal mounting bar being slidably mounted in through bores in the jaws is preferable as this will accommodate numerous different types of mounting kits, including those using hooks, tabs or chains. Locking means such as split pins and other shaped pins could be provided to prevent inadvertent movement of the horizontal mounting pin from the through bores.

Similarly, various locking pins or locking mechanisms could be provided to maintain the retractable crash-bar extension arm 33 in an operating configuration and/or a stowed configuration and similarly, various locking pins or locking mechanisms could be provided to maintain the retractable wheel rests in an operating configuration and/or a stowed configuration. Furthermore, the longitudinal tracks 27 could be bolted onto the vehicle chassis or alternatively, could be welded onto the vehicle chassis, if desired. In another alternative, the longitudinal tracks could be bolted or welded to the mounting frame which in turn would be connected to the chassis. The longitudinal track could be provided with a plurality of holes for reception of a locking member mounted on the frame 29 or vice versa. Alternatively, one or more holes could be provided on both the track and the abutment frame and a nut and bolt or other locking member could be used to engage one or more holes on each of the track and the abutment frame.

The means to mount the mounting kit to the chassis could therefore comprise any suitable connection means including but not limited to nuts and bolts, welding joints and in some instances the means to mount the mounting kit to the chassis could include one or more structural members including one or more parts of the mounting kit that are welded to or bolted to the carrying vehicle chassis and suitable bolt receiving apertures in the mounting kit. The structural bar 63, transverse crash bars 7, 9, tine receiving sockets 35, 37, vertical spacer bars 11, 13, 14 and 61, hanger plates 16 and horizontal structural bar 63 could be welded or bolted directly or indirectly to the vehicle chassis and/or each other, if desired. Indeed, it may be advisable to provide a mixture of the two fixing methods to aid assembly. Similarly, various parts, such as the upper transverse crash bar 7 and vertical spacer bars 11, could already form part of the vehicle chassis assembly.

Another alternative construction incorporates pivotally mounted forklift support receiving brackets. In some instances, the rear brackets protrude from the rear of the truck/trailer significantly and in some cases can cause over length issues with no forklift on board. Therefore, the jaws 23 and mounting pin 25 may be mounted on an assembly which is in turn pivotally connected to the rear cross member 7 on the kit. This assembly has a pivot point underneath item the transverse crash bar 7 and when in the lowered/unused state will not protrude beyond the rear of the kit. Alternatively, the jaws could be pivotally mounted directly onto the transverse crash bar and locking members could be provided to keep them in a desired position protruding from the rear of the chassis or underneath the chassis.

Furthermore, in an alternative embodiment, it is not necessary to mount the forklift machine using forks/tines. In some cases the forklift is mounted using the fork carriage itself and therefore neglecting the forks. This is preferred in certain circumstances as during the mounting process, the forks can take the entire load of the machine and in some cases are not rated to do so. Instead of mounting the forklift using the forks, fork boards are provided (fork carrying rails) to mount the machine usually by fitting hooks that engage the fork carriage of the lifting assembly.

In this specification, the terms “comprise”, “comprises”, “comprised” and “comprising” and the terms “include”, “includes”, “included” and “including” are deemed totally interchangeable and should be afforded the widest possible interpretation.

The invention is in no way limited to the embodiment hereinbefore described but may be varied in both construction and detail.

1-24. (canceled)

25. A mounting kit for fitting on the rear of a carrying vehicle chassis to receive a piggyback forklift truck having a pair of front wheels and a pair of height adjustable, forwardly projecting, load engaging tines, the mounting kit comprising:
a mounting frame having a pair of tine receiving sockets;
means to secure the mounting kit to the chassis;
a pair of forklift support receiving brackets; and
a pair of adjustable wheel abutment plates, one on each side of the tine receiving sockets, moveable forwards and backwards parallel to the longitudinal axis of the carrier vehicle.

26. A mounting kit as claimed in claim 25 in which the wheel abutment plates each comprise a fixed track, an abutment frame moveable relative the track and a releasable fixing member to releasably secure the abutment frame in position relative the track.

27. A mounting kit as claimed in claim 26 in which the abutment frame is slidably mounted on the track.

28. A mounting kit as claimed in claim 26 in which the abutment frame further comprises an inclined plate for bearing against the front wheel of the forklift truck.

29. A mounting kit as claimed in claim 25 in which the pair of forklift support receiving brackets each comprise at least two jaws, each jaw defining a mounting pin receiving aperture, and a mounting pin slidably mounted in the mounting pin receiving apertures of the jaws.

30. A mounting kit as claimed in claim 25 in which there are provided a pair of retractable wheel rest plates, moveable to and from a retracted stored position and an extended in use position, mounted on the mounting frame.

31. A mounting kit as claimed in claim 30 in which the wheel rest plates are pivotally mounted on the mounting frame, pivotable to and from a retracted stored position and an extended in use position.

32. A mounting kit as claimed in claim 25 in which the mounting frame comprises a foldable crash bar, the crash bar comprising a central portion and a pair of extension arms, one at each end of the central portion, the extension arms being foldable to and from a stored position and an extended in use position.

33. A mounting kit as claimed in claim 32 in which the extension arms are pivotally mounted on the central portion, pivotable to and from a stored position and an extended in use position.

34. A mounting kit as claimed in claim 25 in which the mounting frame further comprises a forward section and a rear section,
the forward section comprising a horizontal spacer bar and a pair of forward vertical spacer bars, one at each end of the horizontal spacer bar and projecting upwardly therefrom;
the rear section comprising a horizontal upper transverse crash bar, a lower transverse crash bar below the upper transverse crash bar and connected thereto by way of a pair of rear vertical spacer bars; and
the front section being connected to the rear section by way of the pair of tine receiving sockets being mounted adjacent their rearmost end on the lower transverse crash bar and mounted adjacent their front ends on the forward horizontal spacer bar.

35. A mounting kit as claimed in claim 34 in which the mounting frame further comprises a pair of hanger plates connecting the front and rear sections, each hanger plate being connected to a forward vertical spacer bar and a rear vertical spacer bar.

36. A mounting kit as claimed in claim 34 in which the mounting frame further comprises a pair of intermediate vertical spacer bars located between the pair of front vertical spacer bars and the pair of rear vertical spacer bars and a horizontal structural bar connected to each of the intermediate spacer bars at their lowermost ends.

37. In combination:
a piggyback forklift truck comprising:
a chassis having a pair of front wheels and at least one steerable rear wheel;
a drive unit mounted on the chassis for driving at least one of the wheels;
a steering unit mounted on the chassis for steering the at least one steerable rear wheel;
a load handling unit mounted on the chassis carrying a pair of height adjustable, forwardly projecting, load engaging tines;
means to raise and lower the tines relative the chassis;
means to extend the tines forwardly and retract the tines rearward relative the chassis;
a forklift support mounted on the chassis; and
a carrier vehicle comprising:
a carrier vehicle chassis having mounted thereon a mounting kit for the piggyback forklift truck, the carrier vehicle chassis mounting kit comprising:
a mounting frame having a pair of tine receiving sockets;
means to secure the mounting kit to the chassis;
a pair of forklift support receiving brackets; and
a pair of adjustable wheel abutment plates, one on each side of the tine receiving sockets, moveable forwards and backwards parallel to the longitudinal axis of the carrier vehicle.

38. In the combination as claimed in claim 37 a mounting kit in which the wheel abutment plates each comprise a fixed track and an abutment frame moveable relative the track and a releasable fixing member to releasably secure the abutment frame in position relative the track.

39. In the combination as claimed in claim 38 a mounting kit in which the abutment frame is slidably mounted on the track.

40. In the combination as claimed in claim 38 a mounting kit in which the abutment frame further comprises an inclined plate for bearing against the front wheel of the forklift truck.

41. In the combination as claimed in claim 37 a mounting kit in which the pair of forklift support receiving brackets each comprise at least two jaws, each jaw defining a mounting pin receiving aperture, and a mounting pin slidably mounted in the mounting pin receiving apertures of the jaws.

42. In the combination as claimed in claim 37 a mounting kit in which there are provided a pair of retractable wheel rest plates, moveable to and from a retracted stored position and an extended in use position, mounted on the mounting frame.

43. In the combination as claimed in claim 42 a mounting kit in which the wheel rest plates are pivotally mounted on the mounting frame, pivotable to and from a retracted stored position and an extended in use position.

44. In the combination as claimed of claims 37 a mounting kit in which the mounting frame comprises a foldable crash bar, the crash bar comprising a central portion and a pair of extension arms, one at each end of the central portion, the extension arms being foldable to and from a stored position and an extended in use position.

45. In the combination as claimed in claim 44 a mounting kit in which the extension arms are pivotally mounted on the central portion, pivotable to and from a stored position and an extended in use position.

46. In the combination as claimed in claim 37 a mounting kit in which the mounting frame further comprises a forward section and a rear section,
the forward section comprising a horizontal spacer bar and a pair of forward vertical spacer bars, one at each end of the horizontal spacer bar and projecting upwardly therefrom;
the rear section comprising a horizontal upper transverse crash bar, a lower transverse crash bar below the upper transverse crash bar and connected thereto by way of a pair of rear vertical spacer bars; and
the front section being connected to the rear section by way of the pair of tine receiving sockets being mounted adjacent their rearmost end on the lower transverse crash bar and mounted adjacent their front ends on the forward horizontal spacer bar.

47. In the combination as claimed in claim 46 a mounting kit in which the mounting frame further comprises a pair of hanger plates connecting the front and rear sections, each hanger plate being connected to a forward vertical spacer bar and a rear vertical spacer bar.

48. In the combination as claimed in claim 46 a mounting kit in which the mounting frame further comprises a pair of intermediate vertical spacer bars located between the pair of front vertical spacer bars and the pair of rear vertical spacer bars, and a horizontal structural bar connected to each of the intermediate spacer bars at their lowermost ends.
